(19) United States
(12) Patent Application Publication
(10) Pub. No.: US 2025/0187917 A1
(43) Pub. Date: Jun. 12, 2025

(54) METHOD FOR PREPARING ALUMINUM NITRIDE POWDER

(71) Applicant: NATIONAL CHUNG SHAN INSTITUTE OF SCIENCE AND TECHNOLOGY, Taoyuan City (TW)

(72) Inventors: JIAN-LONG RUAN, Taoyuan City (TW); CHENG-HUNG SHIH, Taoyuan City (TW)

(21) Appl. No.: 18/531,729

(22) Filed: Dec. 7, 2023

(51) Int. Cl. C01B 21/072

(52) U.S. Cl. CPC C01B 21/0726; C01P 2002/72; C01P 2002/85; C01P 2004/03

(57) ABSTRACT

An aluminum nitride powder preparation method, comprises uniformly mixing aluminum with a nitrogen source, carbon source, and halide to form a mixed powder, which is then subject to a high-temperature direct nitridation reaction in a nitrogen-containing gas atmosphere and finally carbon removal in the atmosphere to form a high-purity aluminum nitride powder. The carbon source is mixed with the aluminum powder to form a separator to avoid the problem of melting and agglomeration of aluminum powder. The nitrogen source is mixed into the aluminum powder, and when the nitrogen source is thermally decomposed and the generated gas escapes, numerous pores can be created in the mixed powder, so that the external nitrogen-containing gas atmosphere can easily enter the mixed powder to react with aluminum, thereby improving the nitridation efficiency of aluminum powder.

### BACKGROUND OF THE INVENTION

### 1. Field of the Invention

The present disclosure relates to a method for preparing aluminum nitride powder, and in particular to a method for preparing aluminum nitride powder using aluminum metal powder as a raw material.

### 2. Description of the Related Art

Aluminum nitride (AlN) is a new type of electronic ceramic material. Due to its excellent thermal conductivity and electrical insulation properties, it has become one of the most popular cutting-edge materials. Its special physical properties include high thermal conductivity, high resistivity, low dielectric constant, low thermal expansion coefficient, good heat resistance, good mechanical strength, high chemical stability, non-toxicity, and the like. It can be applied to electronic ceramic substrates, electronic component packaging materials, anti-corrosion components, high thermal conductive additives, and other different application areas.

Aluminum nitride belongs to the hexagonal wurtzite structure. Its atoms are bonded by strong covalent bonds in a tetrahedral configuration, so it has a high melting point and good heat transfer performance. It is one of the few non-metallic solids with high thermal conductivity and has a theoretical density value of 3.26 g/cm³. Since aluminum nitride meets the following four general rules: (1) low atomic weight; (2) strong atomic bonding; (3) simple crystal structure; and (4) high harmonicity of lattice oscillation. Its theoretical value of thermal conductivity coefficient can reach 320 W/mK, as opposed to the thermal conductivity coefficient of commercially available aluminum nitride products ranging from 170 to 230 W/mK. High-purity aluminum nitride is colorless and can transmit light, but its properties are easily affected by chemical purity and density. Since aluminum nitride has a strong affinity for oxygen atoms, during the manufacturing process, part of the oxygen will dissolve into the aluminum nitride crystal lattice to form impurity defects, which will worsen the thermal conductivity. This is because the existence of defects such as impurities in the crystal lattice will cause the scattering of phonons, which will significantly reduce the thermal conductivity; and the aluminum nitride with poor density will also have a lower thermal conductivity coefficient.

At present, the preparation methods of aluminum nitride powder are mainly divided into three types, i.e. direct nitridation method, combustion synthesis method, and carbothermal reduction method:

1. Direct nitridation method: heating aluminum powder in nitrogen gas, during which the aluminum powder is directly nitrided into aluminum nitride powder. The reaction formula is as follows.

2Al₍ₛ₎+N_{2(g)}→2AlN₍ₛ₎

Al and N begin to react at 500° C. At 500˜600° C., the surface oxide film of the aluminum particles reacts to generate volatile low-valent oxides and is removed. Since the nitride film gradually formed on the surface of the particles will make it difficult for nitrogen to penetrate further, causing the nitriding speed to slow down, secondary nitridation must be performed to improve the nitridation efficiency, that is, holding the temperature at 800° C. to carry out the primary nitridation for one hour. After the primary nitridation product has been ball milled, the secondary nitridation is performed at 1200° C., so that uniform aluminum nitride powder can be prepared.

2. Combustion synthesis method: After the aluminum powder is ignited by an external heat source under high pressure, the high chemical reaction heat generated by the reaction between Al and N causes the reaction to sustain itself until the aluminum powder is completely converted into aluminum nitride. The essence of aluminum nitride powder prepared by the combustion synthesis method is still the direct nitridation of aluminum, so the reaction formula is still

2Al₍ₛ₎+N_{2(g)}→2AlN₍ₛ₎

The aluminum nitride powder prepared by this method does not require nitriding for a long time at a temperature higher than 1000° C., unlike the direct nitridation method. It does not require external heat sources except ignition, so it consumes less energy, has low cost, and has high production efficiency. However, during the combustion synthesis process, just like the direct nitridation method, due to the low melting point of aluminum, the molten aluminum is prone to agglomeration at the high temperature of the combustion synthesis reaction, which hinders the penetration of nitrogen into the powder, making it difficult for the aluminum powder to be completely nitrided. Therefore, multiple pulverization and nitridation treatments are required to improve the nitridation level of the reaction product.

3. Carbothermal reduction method: Using ultrafine alumina powder and high-purity carbon black as starting materials, after ball milling and mixing, in a flowing nitrogen atmosphere, carbon black is used to reduce alumina at 1400˜1800° C., and the reduced aluminum is reacted with nitrogen in a flowing state to form aluminum nitride. The reaction equation is as follows.

Al₂O₃₍ₛ₎+3C₍ₛ₎+N_{2(g)}→2AlN₍ₛ₎+3CO

The carbothermal reduction reaction requires a molar ratio of alumina to carbon of 1:3, but for complete conversion of alumina, more carbon is required. Adding an appropriate excess of carbon can not only speed up the reaction rate but also improve the conversion efficiency of alumina powder to obtain aluminum nitride powder with uniform particle size. However, this method also has a shortcoming, that is, the excess carbon must be removed in dry air at 600˜900° C. after the reaction is complete. Although this method requires secondary carbon removal and is more expensive, the omission of subsequent pulverizing and grinding steps allows the carbothermal reduction method to prepare aluminum nitride powder with higher purity.

The disclosure of patent No. CN1544316A discloses a method for preparing high-performance aluminum nitride powder by a combustion synthesis method. The method uses aluminum powder and aluminum nitride diluent in a weight ratio of (1˜3):(1˜7), which are mixed, and then 0.5˜2.5 wt % NH₄F or NH₄Cl additive is added, anhydrous ethanol is used as the medium for ball milling and mixing for 10˜12 hours, followed by the drying process. The dried powder is put into the synthesis reaction kettle, which is pumped to vacuum, followed by filling of nitrogen gas to 8˜10 MPa. Afterward, the ignition agent is ignited to trigger the self-propagating combustion reaction of the aluminum powder for the synthesis of aluminum nitride powder. The disclosure of patent No. CN102531611B discloses a method for preparing aluminum nitride. The method uniformly mixes aluminum powder and a surface modifier to form the reactant. The surface modifier is selected from aluminum hydroxide, aluminum nitrate, magnesium hydroxide, calcium hydroxide, and a combination thereof, and the surface modifier accounts for 0.1˜30% of the total weight of the reactant. Further, the reactant is placed in a container to expose the reactant in the container to a nitrogen-containing gas (gas pressure 0.1˜30 atmospheres), and heated to a temperature above 660° C. to burn the reactant. During the heating process, the surface modifier reacts with the aluminum powder, and a ceramic layer is formed on the surface of the aluminum powder to prevent the aluminum powder from agglomerating due to high-temperature melting. Also, the aluminum powder undergoes a combustion synthesis reaction with the nitrogen-containing gas due to the combustion, thereby forming aluminum nitride.

The disclosure of patent No. CN106744740A discloses a method for preparing aluminum nitride powder. The method fully mixes aluminum powder and 2%˜20% aluminum nitride additive, which is placed in a sintering furnace and heated to 500˜800° C. at a rate of 3˜5° C./min under the atmosphere of N₂ and H₂ mixture and kept at the temperature for 2-6 hours, then cooled to 300° C. at a rate of 3˜7° C./min and then naturally cooled to room temperature to obtain the primary sintering product. After the primary sintering product is pulverized, the flux is added thereto, placed in a sintering furnace and heated to 800˜1100° C. at a rate of 5˜10° C./min under the atmosphere of N₂ and H₂ mixture and kept at the temperature for 6˜9 hours, then cooled to 300° C. at a rate of 3˜7° C./min and then naturally cooled to room temperature to obtain the secondary sintering product, which is pulverized and classified to obtain aluminum nitride powder. The flux is a mixture of NH₄HCO₃ and AlCl₃ with a mass ratio of 1:2. The amount of flux added is ½˜¼ of the aluminum nitride additive.

The disclosure of patent No. TWI496736B discloses a method for manufacturing spherical aluminum nitride powder. The method mixes 100 parts by mass of alumina or hydrated alumina, 0.5˜30 parts by mass of rare earth metal compounds, and 38˜46 parts by mass of carbon powder, which are reduced and nitrided at a temperature of 1620˜1900° C. for more than 2 hours in a nitrogen-containing atmosphere, and then decarbonized with an oxidizing gas. The oxidizing gas is preferably air and the decarbonization treatment temperature is 500˜900° C. for the production of spherical aluminum nitride powder.

CN1435371A discloses a method for preparing ultrafine aluminum nitride powder by a low-temperature carbothermal reduction method, which uses inorganic aluminum salt, i.e. aluminum nitrate, as the aluminum source and water-soluble organic matters such as glucose, sucrose, citric acid, and soluble starch as the carbon source, and also adds urea. The preparation process is as follows: a mixed solution of aluminum nitrate, urea, and water-soluble organic carbon source is prepared in a certain proportion; the mixed solution is heated and dried at a temperature ranging from 100 to 400° C. to obtain a fluffy powder, which serves as a precursor mixture; the precursor is subjected to a reduction and nitridation reaction in a nitrogen atmosphere at a temperature ranging from 1200 to 1600° C. for 1 to 24 hours; and then in an oxygen-containing atmosphere, the product from the reduction and nitridation reaction is calcined at a temperature ranging from 600 to 700° C. for 1 to 7 hours to obtain aluminum nitride powder with an average particle size of less than 0.2 μm.

CN109437919B discloses a method for preparing aluminum nitride ceramic powder based on urea/melamine nitrogen source, which is carried out according to the following steps: (1) preparing raw materials; (2) dissolving aluminum nitrate nonahydrate in water, into which the coupling agent and polyethylene glycol are added and then stirred uniformly; (3) adding the precipitant, followed by stirring until a gel is formed; and washing with alcohol, followed by filtering to obtain the gel; (4) putting the gel into anhydrous ethanol, and adding phenolic resin under stirring conditions to form a paste, followed by drying, calcination and grinding to obtain precursor powder; (5) being ground and mixed with nitrogen source, placed in a heating furnace, and heated to 950˜1500° C. when the pressure in the heating furnace is higher than atmospheric pressure to perform nitridation synthesis; being cooled and ground in the furnace to make coarse powder; and (6) being heated to 550˜650° C. to remove carbon. This disclosure replaces nitrogen with highly active urea/melamine as the nitrogen source in conjunction with the surface modification and dispersion technology to achieve uniform mixing between the aluminum source and the carbon source at the atomic or molecular level and reduce the temperature for the carbothermal reduction reaction.

Currently, the common methods for synthesizing aluminum nitride powder are mainly the direct nitridation method, combustion synthesis method, and carbothermal reduction method. The advantages of the direct nitridation method of aluminum powder are low cost, wide source of raw materials, low equipment cost, and simple manufacturing process. However, the nitridation reaction process is difficult to control, the product quality stability is poor, and the generated products are easy to agglomerate such that subsequent grinding and pulverizing steps are required, which will extend the preparation cycle and increase production costs, and impurities are easily introduced during the grinding and pulverizing process, affecting the purity of aluminum nitride powder. The combustion synthesis method mainly uses the high chemical reaction heat generated by the reaction of aluminum and nitrogen to make the reaction proceed spontaneously without the need for external heat sources. It consumes less energy and has high production efficiency. However, such a method needs to be carried out under high pressure, which requires high equipment performance, and the spontaneous reaction process is difficult to control. At the same time, under the high temperature of the combustion synthesis reaction, the molten aluminum is prone to agglomeration, so the generated product also needs grinding and pulverizing treatments, which is extremely detrimental to the production cost cycle control and the synthesis purity of aluminum nitride powder. The carbothermal reduction method has the advantages of wide sources of raw materials, high purity of synthesized powder, stable performance, and uniform powder particle size distribution, and is not easy to agglomerate, so it is an ideal method for industrial production of aluminum nitride powder. However, this method has high-quality requirements for the starting raw materials such as alumina and carbon black, the raw materials are difficult to mix evenly, the reaction temperature is high, and the synthesis time is long. In addition, excess carbon needs to be removed after the reaction, so the process is relatively complicated.

Given the lack of conventional technology, the present disclosure provides a method for preparing aluminum nitride powder to solve the above problems, in which aluminum powder is used as the starting raw material to improve the process technology of the direct nitridation method concerning the carbothermal reduction concept. The carbon source is added to the aluminum powder starting material as a separator to avoid the problem of high-temperature melting and agglomeration of aluminum powder and to omit the subsequent grinding and pulverizing actions. At the same time, the nitrogen source is mixed into the aluminum powder, and when the nitrogen source is thermally decomposed and the generated gas escapes, numerous pores can be created in the mixed powder, so that the external nitrogen-containing gas atmosphere can easily enter the mixed powder to react with aluminum, thereby improving the nitridation efficiency of aluminum powder. In addition, adding halide to the aluminum powder starting material can catalyze the nitridation reaction of aluminum, improve the nitridation effect, and contribute to the synthesis of high-purity aluminum nitride powder. The following is a brief description of the present application.

### BRIEF SUMMARY OF THE INVENTION

The present disclosure relates to a method for preparing aluminum nitride powder and, in particular, to a method for preparing aluminum nitride powder using aluminum metal powder as the raw material. The present disclosure combines the steps of aluminum powder precursor mixture preparation, high-temperature nitridation, and atmospheric carbon removal to provide an aluminum nitride powder preparation method that is different from the general direct nitridation of aluminum powder and can effectively improve the nitridation efficiency of aluminum powder. Simultaneously, it can eliminate the subsequent grinding and pulverizing steps due to the aggregation of aluminum powder, reduce the introduction of excess impurities, and improve the purity of the produced aluminum nitride powder.

According to the concept of the present disclosure, a method for preparing aluminum nitride powder is provided and includes the following steps: (A) providing an aluminum metal powder, a nitrogen source, a carbon source, and a halide and uniformly mixing the aluminum metal powder with the nitrogen source, the carbon source, and the halide to form a mixed powder; (B) performing a high-temperature direct nitridation reaction on the mixed powder in a nitrogen-containing gas atmosphere to form a completely nitrided aluminum nitride powder;

and (C) removing carbon from the completely nitrided aluminum nitride powder in atmosphere to form a high-purity aluminum nitride powder.

In step (A) described above, the aluminum metal powder has a purity of more than 99% and an average particle size between 10 and 100 μm; the nitrogen source is selected from nitrogen amine organics or inorganic ammonium salts, such as urea, melamine, ammonium carbonate, ammonium bicarbonate, ammonium nitrate, ammonium formate, ammonium acetate, and the like, and has a purity of more than 99% and an average particle size between 10 and 100 μm; and the halide is selected from halogen-containing inorganic salts or organic polymers, such as aluminum chloride, ferric chloride, aluminum bromide, sodium fluoride, calcium fluoride, polytetrafluoroethylene, and the like, and has a purity of more than 99% and an average particle size between 10 and 100 μm; and the carbon source is selected from graphite, carbon black, or activated carbon, and has a purity of more than 99%, an average particle size of less than 30 μm, and a BET specific surface area of 0.1˜500 m²/g.

The uniform mixing process in step (A) described above is one of the dry and wet mixing processes, but the wet mixing process needs a drying procedure to obtain a mixed powder. The weight ratio of the aluminum metal powder, the nitrogen source, the carbon source, and the halide for mixing is 1:0.5˜1:0.3˜1:0.01˜0.1.

The high-temperature nitridation reaction in step (B) described above is performed at a temperature between 1200° C. and 1800° C. for a reaction time of 1˜10 hours.

The nitrogen-containing gas in step (B) described above is selected from the group consisting of ammonia, nitrogen, a gas mixture of nitrogen and hydrogen, and a combination thereof.

The removal of carbon in step (C) described above is performed at a temperature between 500° C. and 900° C. for a carbon-removing time of 1˜20 hours.

The present disclosure uses aluminum powder as the starting raw material to improve the process technology of the direct nitridation method concerning the carbothermal reduction concept. The carbon source is added to the aluminum powder starting material as a separator to avoid the problem of high-temperature melting and agglomeration of aluminum powder and to omit the subsequent grinding and pulverizing actions. At the same time, the nitrogen source is mixed into the aluminum powder, and when the nitrogen source is thermally decomposed and the generated gas escapes, numerous pores can be created in the mixed powder, so that the external nitrogen-containing gas atmosphere can easily enter the mixed powder to react with the aluminum, thereby improving the nitridation efficiency of the aluminum powder. In addition, the addition of halide can catalyze the nitridation reaction of aluminum, improve the nitridation effect, and contribute to the synthesis of high-purity aluminum nitride powder.

The technology of the present disclosure retains the advantages of the carbothermal reduction method, improves the shortcomings of the direct nitridation method, and provides an aluminum nitride powder preparation method that is different from the general direct nitridation of aluminum powder, and can avoid the problems of aluminum powder aggregation resulting from the direct nitridation method. Compared with the direct nitridation method of aluminum powder, although the present disclosure additionally introduces the mixing and carbon removal steps, it can also omit the subsequent grinding and pulverizing steps to avoid the introduction of excess impurities and retain the advantage of higher aluminum nitride powder purity resulting from the carbothermal reduction method.

The above summary and the following detailed description and drawings are all intended to further illustrate the methods, means, and effects adopted by the present disclosure to achieve the intended purpose. Other objects and advantages of the present disclosure will be elaborated in the subsequent description and drawings.

### BRIEF DESCRIPTION OF THE DRAWINGS

FIG. 1 is a flow chart of a method for preparing aluminum nitride powder according to an embodiment of the present disclosure.

FIG. 2 shows the X-ray diffraction pattern of aluminum nitride powder after high-temperature direct nitridation and atmospheric carbon removal of starting powders of different formulations according to embodiments of the present disclosure.

FIG. 3 shows a physical photo of aluminum nitride powder produced after high-temperature direct nitridation and atmospheric carbon removal according to an embodiment of the present disclosure.

FIG. 4 is a scanning electron microscope (SEM) photo of aluminum nitride powder after high-temperature direct nitridation and atmospheric carbon removal according to an embodiment of the present disclosure.

FIG. 5 is an energy-dispersive spectroscopy (EDS) composition and particle size analysis table of aluminum nitride powder after high-temperature direct nitridation and atmospheric carbon removal according to an embodiment of the present disclosure.

### DETAILED DESCRIPTION OF THE INVENTION

The following is an illustration of embodiments of the present disclosure through specific examples. Those skilled in the art can easily understand the advantages and effects of the present disclosure from the contents disclosed in the specification.

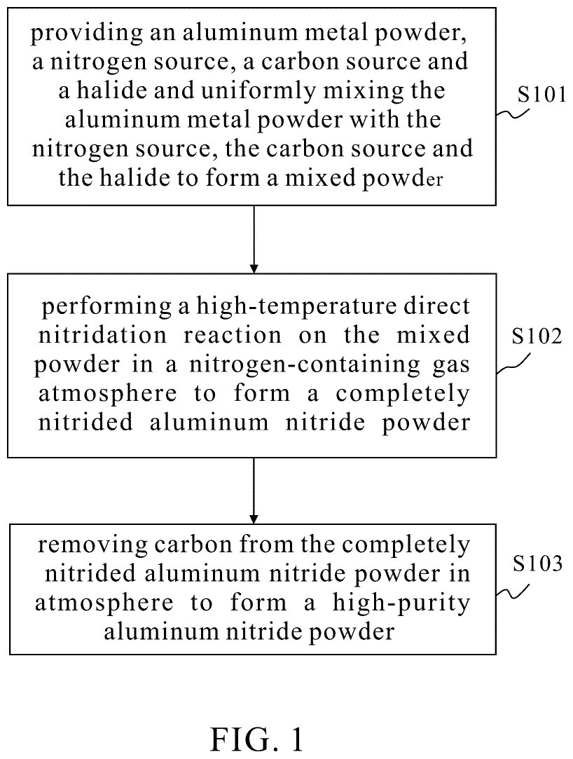

Refer to FIG. 1, which is a flow chart of a method for preparing aluminum nitride powder of an embodiment of the present disclosure, in which step S101 provides an aluminum metal powder, a nitrogen source, a carbon source, and a halide, which are uniformly mixed to form a mixed powder; step S102 performs a high-temperature direct nitridation reaction on the mixed powder in a nitrogen-containing gas atmosphere to form a completely nitrided aluminum nitride powder; and step S103 removes carbon from the completely nitrided aluminum nitride powder in atmosphere to form a high-purity aluminum nitride powder.

The aluminum metal powder described in step S101 is preferably a granulated aluminum powder with a purity of more than 99% and an average particle size of 30 to 80 μm in an embodiment; and the carbon source described in step S101 is preferably carbon black with a purity of more than 99%, an average particle size of less than 30 μm and a Brunauer-Emmett-Teller (BET) specific surface area of 0.1˜100 m²/g in an embodiment.

The nitrogen source described in step S101 is preferably melamine with a purity of more than 99% and an average particle size of less than 50 μm in an embodiment, and the halide described in step S101 is preferably polytetrafluoroethylene with a purity of more than 99% and an average particle size between 20 and 60 μm in an embodiment.

For the mixed powder described in step S101, the preferred mixing weight ratio in an embodiment is aluminum powder:melamine:carbon black:polytetrafluoroethylene=1:0.5˜ 1:0.3˜ 0.5:0.01˜ 0.05.

In the mixed powder, if the carbon source is used in an excessive amount, the above-mentioned aluminum source will exist in the mixture in a loose state. When heat treatment is performed for nitridation, the particles of aluminum nitride will not be able to fully grow, affecting the crystallinity. Too much usage of carbon sources will increase the difficulty of subsequent carbon removal steps. Too little usage of carbon sources will cause the aluminum powder to agglomerate severely, and the aluminum nitride powder obtained will contain many coarse particles or form agglomerates and will need further grinding and pulverizing treatments.

The temperature for the high-temperature direct nitridation reaction described in step S102 is preferably 1400˜1600° C. in an embodiment, and the reaction time is preferably 4˜8 hours. The nitrogen-containing gas described in step S103 is preferably nitrogen.

The carbon removal treatment described in step S103 is to oxidize and remove carbon, and it is performed using an oxidizing gas. As this oxidizing gas, any gas that can remove carbon, such as air, oxygen, etc., can be used without any restrictions, but considering the economy and the oxygen concentration of the produced aluminum nitride, air (atmospheric atmosphere) is preferably used as the oxidizing gas in an embodiment. In addition, considering the efficiency of carbon removal and excessive oxidation of the aluminum nitride surface, the carbon removal temperature in an embodiment is preferably 600˜750° C., and the carbon removal time is preferably 1˜10 hours.

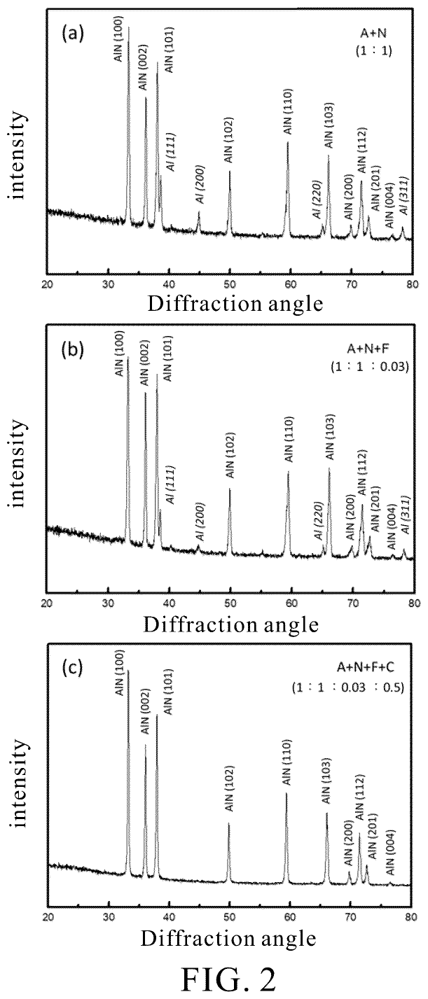

Please refer to FIG. 2, which is the X-ray diffraction pattern of aluminum nitride powder after high-temperature direct nitridation and atmospheric carbon removal of starting powders of different formulations according to embodiments of the present disclosure. In this example, A+N represents that the starting powder is aluminum powder plus melamine (with a weight ratio of 1:1); A+N+F represents that the starting powder is aluminum powder plus melamine plus polytetrafluoroethylene (with a weight ratio of 1:1:0.03); A+N+F+C represents that the starting powder is aluminum powder plus melamine plus polytetrafluoroethylene plus carbon black (with a weight ratio of 1:1:0.03:0.5). Using the above different starting powders to carry out the high-temperature direct nitridation at 1600° C. with a reaction time of 5 hours, the X-ray diffraction patterns of the produced powders are compared as shown in FIG. 2. If only aluminum powder plus melamine is used as the starting powder to carry out the high-temperature direct nitridation reaction, it can be seen from FIG. 2(a) that although the aluminum nitride phase is formed, the diffraction peak of aluminum metal remains. If aluminum powder plus melamine plus polytetrafluoroethylene is used as the starting powder to carry out the high-temperature direct nitridation reaction, it can be seen from FIG. 2(b) that the diffraction peak intensity of the residual aluminum metal has been significantly reduced, which means that the addition of polytetrafluoroethylene helps to promote the nitridation reaction of the aluminum metal, thereby improving the nitridation efficiency of aluminum powder. If aluminum powder plus melamine plus polytetrafluoroethylene plus carbon black is used as the starting powder for high-temperature direct nitridation and the carbon removal is completed, it can be seen from FIG. 2(c) that the output powder has completely formed the aluminum nitride phase, the aluminum metal diffraction peak has disappeared, and there is no residue of the starting aluminum powder and carbon black, thereby forming a high-purity aluminum nitride powder.

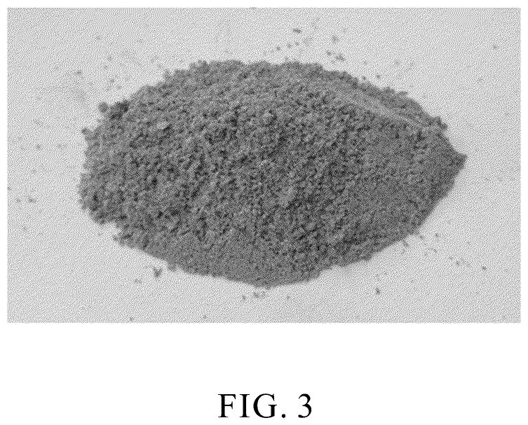

Please refer to FIG. 3, which is a physical photo of aluminum nitride powder produced after high-temperature direct nitridation and atmospheric carbon removal according to embodiments of the present disclosure. Aluminum powder, melamine, carbon black, and polytetrafluoroethylene are mixed by dry ball milling according to the weight ratio of 1:1:0.5:0.03 to form a uniformly mixed precursor, which is used as the starting powder to perform high-temperature direct nitridation at 1600° C. for a reaction time of 5 hours. It can be seen in the photo that the aluminum nitride produced by an embodiment of the present disclosure is in the form of powder, and no melting and agglomeration of aluminum powder occurs. Therefore, it can be seen that the present disclosure is different from the general direct nitridation method of aluminum powder and can directly produce powdery aluminum nitride, omit subsequent grinding steps, and reduce the chance of impurity introduction.

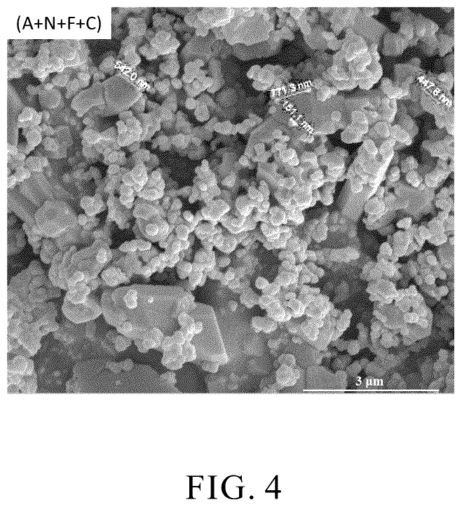

Please refer to FIG. 4, which is an SEM photo of aluminum nitride powder after high-temperature direct nitridation and atmospheric carbon removal according to an embodiment of the present disclosure. A+N+F+C means that the starting powder is aluminum powder plus melamine plus polytetrafluoroethylene plus carbon black (with a weight ratio of 1:1:0.03:0.5). After the starting powder is directly nitrided at high temperature and carbon removal is completed, it can be seen from the SEM in FIG. 4 that the produced powdery crystal is approximately in the shape of a hexagonal column, which is a typical manifestation of hexagonal crystal structure of aluminum nitride. At the same time, the grain sizes vary from large to small, in which large grains can be more than 2 to 3 μm, while small grains range from about 100 to 200 nm.

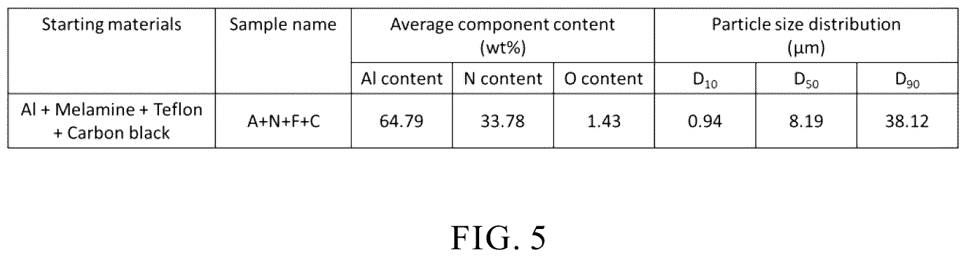

Please refer to FIG. 5, which is an EDS composition and particle size analysis table of aluminum nitride powder after high-temperature direct nitridation and atmospheric carbon removal according to an embodiment of the present disclosure. A+N+F+C means that the starting powder is aluminum powder plus melamine plus polytetrafluoroethylene plus carbon black (with a weight ratio of 1:1:0.03:0.5). After the starting powder is directly nitrided at high temperature and carbon removal is completed, it can be found from the EDS composition analysis data in FIG. 5 that the average Al content of the output powder is 64.79 wt %, the average N content is 33.78 wt %, and the average O content is 1.43 wt %. If the O content is deducted, the molar percentage of AlN is calculated to be about 2.40:2.41, which is close to the theoretical molar ratio of AlN of 1:1. In addition, the presence of O content may be due to the adsorption of oxygen from the atmosphere on the surface of aluminum powder. The particle size analysis results show that the D₁₀, D₅₀, and D₉₀ of the aluminum nitride powder of an embodiment are 0.94 μm, 8.19 μm, and 38.12 μm respectively, and the average particle size falls around 7 to 8 μm.

As illustrated by the above embodiments, a method for preparing aluminum nitride powder according to the present disclosure uses aluminum powder as a starting material, refers to the carbothermal reduction concept, and improves the direct nitridation process technology. Specifically, the carbon source, the nitrogen source, and the halide are added into the aluminum powder starting raw materials and mixed to form a precursor mixture for high-temperature direct nitridation. After high-temperature direct nitridation and atmospheric carbon removal, a high-purity aluminum nitride powder can be formed. The disclosure can effectively avoid the problem of high-temperature melting and agglomeration of aluminum powder, omit subsequent grinding and pulverizing operations, and reduce the probability of impurity introduction. Simultaneously, it can improve the nitridation efficiency of aluminum powder and contribute to the synthesis of high-purity aluminum nitride powder. The present disclosure can also use recycled aluminum powder smelted and atomized from scrap aluminum targets as the starting raw material to produce aluminum nitride powder with high economic value, which strengthens the recycling and regeneration application of waste materials, and promotes the development of the recycling economy industry.

The embodiments described above are only for illustrating the characteristics and effects of the present invention and are not intended to limit the scope of the essential technical content of the present invention. Those skilled in the art can make modifications and changes to the above embodiments without departing from the spirit and scope of the invention. Therefore, the protection scope of the present invention should be subject to the appended claims.

What is claimed is:

1. A method for preparing aluminum nitride powder, comprising:
(A) providing an aluminum metal powder, a nitrogen source, a carbon source, and a halide and uniformly mixing the aluminum metal powder with the nitrogen source, the carbon source, and the halide to form a mixed powder;
(B) performing a high-temperature direct nitridation reaction on the mixed powder in a nitrogen-containing gas atmosphere to form a completely nitrided aluminum nitride powder; and
(C) removing carbon from the completely nitrided aluminum nitride powder in atmosphere to form a high-purity aluminum nitride powder.

2. The method for preparing aluminum nitride powder of claim 1, wherein the aluminum metal powder in step (A) has a purity of more than 99% and an average particle size between 10 and 100 μm; and the carbon source in step (A) is selected from the group consisting of graphite, carbon black, and activated carbon, and has a purity of more than 99%, an average particle size of less than 30 μm and a BET specific surface area of 0.1˜500 m²/g.

3. The method for preparing aluminum nitride powder of claim 1, wherein the nitrogen source in step (A) is selected from the group consisting of urea, melamine, ammonium carbonate, ammonium bicarbonate, ammonium nitrate, ammonium formate, and ammonium acetate, and has a purity of more than 99% and an average particle size between 10 and 100 μm; and the halide in step (A) is selected from the group consisting of aluminum chloride, ferric chloride, aluminum bromide, sodium fluoride, calcium fluoride, and polytetrafluoroethylene, and has a purity of more than 99% and an average particle size between 10 and 100 μm.

4. The method for preparing aluminum nitride powder of claim 1, wherein the uniform mixing method in step (A) is one of dry mixing process or wet ball milling process.

5. The method for preparing aluminum nitride powder of claim 1, wherein a mixing weight ratio of the aluminum metal powder, the nitrogen source, the carbon source, and the halide in step (A) is 1:0.5˜1:0.3˜1:0.01˜0.1.

6. The method for preparing aluminum nitride powder of claim 1, wherein the high-temperature direct nitridation reaction in step (B) is performed at a temperature between 1200° C. and 1800° C. for a reaction time of 1˜10 hours.

7. The method for preparing aluminum nitride powder of claim 1, wherein the nitrogen-containing gas atmosphere in step (B) is selected from the group consisting of ammonia, nitrogen, air, a gas mixture of nitrogen and hydrogen, and a combination thereof.

8. The method for preparing aluminum nitride powder of claim 1, wherein the removal of carbon in step (C) is performed at a temperature between 500° C. and 900° C. for a carbon-removing time of 1˜20 hours.
